(19) United States
(12) Patent Application Publication
(10) Pub. No.: US 2017/0169917 A1
(43) Pub. Date: Jun. 15, 2017

(54) METHOD AND DEVICE FOR AVOIDING HARMONIC WAVES

(71) Applicant: Guangrong Luo, Zunyi City, Guizhou (CN)

(72) Inventors: Guangrong Luo, Zunyi City, Guizhou (CN); Changyong Liang, Zunyi City, Guizhou (CN); Hua Zhang, Zunyi City, Guizhou (CN); Jianyu Wang, Zunyi City, Guizhou (CN); Wenyong Zhong, Zunyi City, Guizhou (CN); Xiaobo Liu, Zunyi City, Guizhou (CN); Fengzhu Zhang, Zunyi City, Guizhou (CN); Wenwei Xin, Zunyi City, Guizhou (CN); Yi Ji, Zunyi City, Guizhou (CN); Tian Luo, Zunyi City, Guizhou (CN)

(21) Appl. No.: 15/322,255

(22) PCT Filed: Jun. 29, 2015
(86) PCT No.: PCT/CN2015/082711

§ 371 Date: Mar. 1, 2017

(30) Foreign Application Priority Data
Jun. 27, 2014 (CN) 201410293485.8

(51) Int. Cl. H01B 7/02; H02J 3/01; H02J 1/08; H02J 1/02

(52) U.S. Cl. CPC H01B 7/0208; H02J 1/02; H02J 3/01; H02J 1/08; H01B 7/0241; H01B 7/0275

(57) ABSTRACT

It is found and confirmed that a harmonic wave source is a traditionally-used multi-core wire with mutually-exposed core wires. By using a multi-core wire or a single-core wire with mutually-insulated core wires to replace the traditionally-used multi-core wire, a large number of harmonic waves produced by the mutually-exposed core wires can be avoided, the working quality of a power utilization device and an electric energy and electrical signal transmission network is improved at low costs, and electric energy is saved. A method for using a lead wire structure with insulated core wires is used to avoid harmonic ripple noise produced in seamed transmission, or to avoid electric energy waste caused by harmonic ripple noise produced in seamed transmission, or to avoid the influence of harmonic ripple noise produced in seamed transmission on the working quality of a power utilization device or an electric energy and/or electrical signal transmission network. A power utilization device other than an earphone and an electric energy and electrical signal transmission network system, comprising a multi-core transmission lead wire, wherein one or some or all of core wires of the multi-core transmission lead wire are mutually insulated.

### TECHNICAL FIELD

The present application relates to harmonic suppression, and particularly to a novel use of a cable structure, and to an electricity related device and an electric energy and/or electrical signal transmission network, and further to a filter.

### BACKGROUND ART

As for electricity related devices and electric energy and/or electrical signal transmission networks, there have been various traditional technical solutions for harmonic suppression. However, none of these technical solutions involves structures of the electricity related devices or the electric energy and/or electrical signal transmission cables.

Various types of multi-core cables are commonly used for internal electric energy distributing and transmitting cables, external electric energy input cables, internal signal distribution and transmission cables and external signal input cables of the electricity related device, and for the electric energy and/or electrical signal transmission network. The structures of such multi-core cables have a common feature that multiple core wires, serving as one transmission channel together, are not insulated from each other after being gathered, that is, they are all bare wires. However, there is an exception as follows.

A mono earphone (insert earphone) used a few decades ago belongs to an electricity related device. It adopts a signal transmission cable from a sound source to a speaker terminal, where multiple enameled wires are adopted for the signal transmission cable in such a manner that they are divided into two groups to form two transmission channels, and furthermore, an insulation sheath is wrapped outside the enameled wires, so that the signal transmission wire looks like one wire in appearance. The purpose of such solution is to get rid of the insulating sheath for one channel, so that the external diameter of the cable of the earphone becomes smaller, so as to obtain soft feeling. Due to the use of the enameled wires, each core wire is in an insulated state. Such core wires have characteristics that all surfaces thereof are provided with an insulation layer which is flat and smooth, and they all have a solid and circular cross section of a same diameter, and furthermore, they use ordinary materials and simple technologies, without any further special points, that is, they are products of traditional production apparatus and technology for wires.

Such a cable structure having core wires insulated from each other has not yet been widely applied so far. Although a stereophone cable having three transmission channels adopts a solution in which core wires are insulated from each other, a part of high-end earphone cables produced in the prior art still generally adopt a multi-core cable solution in which multiple core wires are not insulated from each other. Even in the field of high-fidelity which has always been devoted to the transmission quality of an electrical signal and has done the most studies about wires, no focus has yet been brought into the association between harmonics and their induced ripples and noises and the fact whether the multiple core wires are insulated from each other, not to mention other fields.

The insulation solution used in the previously described cable structure in which the core wires are insulated from each other still needs to be supplemented.

Traditional filters and filtering units also have their deficiencies. Specifically, as adopting technical means of a magnetic ring, a reactor, a capacitor, an isolation transformer, an electronic component, a regenerated power or a digital wave filter, they are all limited to “passive suppression”, that is, they interfere after the harmonics are produced. These solutions have such problems as a limited power (especially a transient power), or high costs.

Heretofore, there has been no research report regarding whether there is an association between harmonics and a structure of a transmission cable having core wires insulated or uninsulated from each other that is adopted in an electricity related device and an electric energy and/or electrical signal transmission network. In other words, as for the technical problem of harmonics, no suggestion has been given in terms of the cable structure in the prior art, and a major harmonic source hidden in the electricity related device and the electric energy and/or electrical signal transmission network has not been found so far. In addition, traditional filters still need to be improved in terms of effect, cost and power, and etc. Moreover, the insulation solution for cables still needs to be supplemented.

### DISCLOSURE OF THE INVENTION

In view of the deficiencies of the above-mentioned traditional theories and technical solutions, objects of the present application are to: provide a novel use of a cable structure with insulated core wires directed against the harmonic source “seamed transmission”; provide various electricity related devices and electric energy and/or electrical signal transmission networks adopting this novel use; provide an insulation solution for core wires; and provide a filter that attenuates harmonics by taking advantage of a long distance and avoids harmonics from being produced by its own seamed transmission. These solutions can eliminate bad contact between core wires of a multi-core cable traditionally used in an electricity related device and an electric energy and/or electrical signal transmission network and also a short-circuit current resulted therefrom, avoid harmonics produced by the traditional multi-core cable and ripples and noises that are induced from the harmonics, improve the working quality of various electricity related devices and transmission networks, and save electric energy.

The objects of the present application are realized as follows.

A novel use of a cable structure with insulated core wires is provided, where the cable structure is configured to avoid harmonics, ripples and noises produced by use of a solution of seamed transmission of electric energy and/or an electrical signal; or configured to avoid electric energy waste caused by the harmonics, ripples and noises produced by the seamed transmission of the electric energy and/or electrical signal; or configured to avoid the harmonics, ripples and noises produced by the seamed transmission of the electric energy and/or electrical signal from influencing a working quality of an electricity related device and a working quality of an electric energy and/or electrical signal transmission network system.

The novel use of the cable structure is specifically configured to transmit and distribute electric energy within the electricity related device, or configured to input or output electric energy to or from the electricity related device, or configured to transmit an electrical signal within the electricity related device, or configured to input or output an electrical signal to or from the electricity related device, or applicable to a high voltage AC electric energy transmission network system, or applicable to a low voltage AC electric energy transmission network system, or applicable to a DC electric energy transmission network system, or applicable to an electrical signal transmission network system, or applicable to manufacturing multi-core transmission cables of various types and various specifications that are adapted to different voltages and different flows and enable seamless transmission of the electric energy and/or electrical signal.

The cable structure with insulated core wires that is used for the novel use of the cable structure includes one or more transmission channels constituted by multi-core cables, or includes one or more transmission channels constituted by single-core cables, or includes more than two transmission channels constitute by multi-core cables and single-core cables in combination.

An electricity related device which is not earphones is provided, which includes multi-core transmission cables for transmitting and distributing electric energy within the electricity related device, inputting external electric energy, outputting electric energy, transmitting an electrical signal internally, inputting an external electrical signal, or outputting an electrical signal, where one or part or all of these multi-core transmission cables have individual core wires used for transmission insulated from each other, with such core wires used for transmission provided in these multi-core transmission cables.

Within the multi-core cable used in the electricity related device, individual core wires used for transmission are insulated from each other by adopting an insulation solution, in which: surfaces of the core wires are coated with an insulating paint, or wrapped with an oxide insulation layer, or wrapped with an electrostatic coating; or insulated segments and bare wire segments are provided alternately, or bare core wires and insulated core wires are arranged alternately; or the core wires are wound with a strip-like insulator, or wrapped with a powder insulation layer, or wrapped with a release layer and an insulation layer; or a wrapped insulation layer falls off automatically after a period of time, or falls off when being rubbed by a finger; or a positioning device is used to form a spatial distance between the core wires.

In the multi-core cables used in the electricity related device, the insulating paint used for the core wire is polyurethane, or a main component of the insulating paint includes polyurethane.

In the multi-core cables used in the electricity related device, the core wires of one multi-core cable are conductors of a same material, or conductors of two or more different materials; or conductor materials of two or more of the multi-core cables are different from each other; or some of the individual core wires of the multi-core transmission cables can be made of any material so as to be uninsulated, and the uninsulated core wires are configured for purposes other than transmitting electric energy and/or an electrical signal.

The core wires used for transmission of the multi-core cable used in the electricity related device have a same diameter; or the multi-core cables used in the electricity related device are of a circular cross section; or each of the core wires used for transmission of the multi-core cable used in the electricity related device is of a circular cross section; or multiple core wires of the multi-core transmission cable are stranded to form one transmission channel; or multiple core wires of the multi-core transmission cable are linearly collocated without being stranded, to form one transmission channel; or multiple core wires are in different lengths, with part of the multiple core wires stranded and the remaining being linear, and the two stranded and the linear wires forming one transmission channel.

In the multi-core cables used in the electricity related device, one end or both ends of the multi-core cable is provided with a plug connector, and the plug connector is configured for connection with individual units within an electricity related device having a corresponding plug connector, or for connection with an electricity related device having a corresponding plug connector; and the multi-core cable is provided with a shielding layer, a vibration reducing layer or a filtering magnetic ring, or the multi-core cable has one or more transmission channels and is free of a peripheral insulation layer.

Among the multi-core cables used in the electricity related device, one or more of the multi-core cables each have more than one transmission channels

The multi-core cables used in the electricity related device are subjected to an aging treatment when being energized, during manufacture of the cables or the electricity related device.

The electricity related device is a filtering device, and the filtering device is provided with a multi-core cable or single-core cable with a length of more than 50 cm, and is configured to attenuate harmonics, ripples and noises from electric energy and/or an electrical signal.

In the filtering device, a starting end and a trailing end of the cable used for filtration have unequal diameters, with the starting end having a diameter larger than that of the trailing end; or the starting end of the cable used for filtration is provided with a step-up transformer, and the trailing end of the cable used for filtration is provided with a step-down transformer; or the cable used for filtration is exposed to insulating oil; or the filtering device is provided with a filtering unit for low-order harmonics.

An electric energy and/or electrical signal transmission network system is provided, which includes multi-core transmission cables for transmitting AC electric energy, DC electric energy or an electrical signal, where one or part or all of these multi-core transmission cables have individual core wires used for transmission insulated from each other, with the core wires used for transmission provided in the multi-core transmission cables.

Within the multi-core cable used in the network system, individual core wires used for transmission are insulated from each other by adopting an insulation solution, in which: surfaces of the core wires are coated with an insulating paint, or wrapped with an oxide insulation layer, or wrapped with an electrostatic coating; or insulated segments and bare wire segments are provided alternately, or bare core wires and insulated core wires are arranged alternately; or the core wires are wound with a strip-like insulator, or wrapped with a powder insulation layer, or wrapped with a release layer and an insulation layer; or a wrapped insulation layer falls off automatically after a period of time, or falls off when being rubbed by a finger; or a positioning device is used to form a spatial distance between the core wires.

In the network system, the insulating paint used for the multi-core cables is polyurethane, or a main component of the insulating paint includes polyurethane.

An object to be transmitted by the network system is low-voltage AC electric energy.

In the multi-core cables used in the network system, the core wires within one of the multi-core cables are conductors of a same material, or conductors of two or more different materials; or conductor materials of two or more of the multi-core cables are different from each other; or some of the individual core wires of the multi-core transmission cables can be made of any material so as to be uninsulated, and the uninsulated core wires are configured for purposes other than transmitting electric energy and/or an electrical signal.

The core wires used for transmission of the multi-core cables used in the network system have a same diameter; or the multi-core cables used in the network system are of a circular cross section; or the core wires used for transmission of the multi-core cables used in the network system are of a circular cross section; or multiple core wires of the multi-core transmission cable are linearly collocated without being stranded, to form one transmission channel; or multiple core wires are in different lengths, with part of the multiple core wires stranded and the remaining being linear, and the stranded and the linear wires forming one transmission channel.

One end or both ends of the multi-core cable used in the network system is provided with a plug connector, and the plug connector is configured for connection with individual units within an electricity related device having a corresponding plug connector, or for connection with an electricity related device having a corresponding plug connector; and the multi-core cable is provided with a shielding layer, a vibration reducing layer or a filtering magnetic ring, or the multi-core cable is free of a peripheral insulation layer.

The above-mentioned solutions provide the following beneficial effects:

(1) The harmonic source “seamed transmission” and solutions for eliminating the same are found and confirmed.

The concept “seamed transmission” originates from a traditional multi-core cable structure having multiple core wires that are not insulated from each other, where under such a structure, there is always a radial gap, i.e., “seam”, between adjacent core wires, no matter how the core wires are adjacent to each other. Such a radial gap causes adjacent core wires to be always in an incompletely conducting state, that is, in a bad contact, if the core wires are not insulated. The bad contact would cause electric sparks (for example, electric sparks would be visible at a moment that a power plug and a power socket are brought to be contact with or separated from each other). Although an electric spark is hardly aroused as there are tiny and constant intervals among the core wires of the multi-core cable, such a bad contact would inevitably cause a “short-circuit current” among the core wires.

The “short-circuit current” is resulted from the cable structure and the characteristics of current. As for a multi-core cable having core wires uninsulated from each other and slightly stranded, each core wire thereof is longer than the length of the stranded wire. One of the characteristics of current (the electric energy and/or electrical signal) is that it travels along the shortest path. Thus, it becomes inevitable for the current (an AC or DC electric energy and/or electrical signal) to step over the “seam”, i.e., the gap, between the core wires, in the multi-core cable having core wires uninsulated from each other. Such a current stepping over the gap between the core wires may be deemed as a “short-circuit current”. The smaller the pitch of the cable is, the greater the “short-circuit current” is, and the bigger the harmonic component is. It is experimentally proved in the present application that, as for a multi-core cable having core wires uninsulated form each other and not stranded, it falls in the range of seamed transmission, and there is also a “short-circuit current”.

It is experimentally proved in the present application that, such a “short-circuit current” caused by the seamed transmission is a harmonic source that has not been reported in any researches yet, and it causes the seamed transmission to produce harmonics and induced ripples and noises over the transmission and results in electric energy waste, just like a water pipe with leakages all around the pipe.

Unlike the “seamed transmission”, the multiple core wires within the previously described earphone cable are insulated from each other, which may cause “seamless transmission”. Although there is still a gap between the core wires, the current in each core wire is restrained by the insulation layer, and thus cannot flow to an adjacent core wire. Therefore, it is possible to fundamentally restrict the “seamed transmission” from inducing a “short-circuit current” which results in harmonics, ripples and noises. As the “seamless transmission” is defined according to the restraint on the current that is caused by the insulation layer, a single-core cable also falls in the range of seamless transmission.

With a measuring instrument, the effect that the “seamless transmission” avoids harmonics can be observed. Without intervening in harmonics of the mains grid, one traditional multi-core cable of seamed transmission and one multi-core cable constituted by multiple enameled wires, both of which having a length of 100 meters, are respectively used as an electric energy connection cable between a mains socket and a load, and an instrument for measuring harmonic components is connected at an end of the connection cable close to the load. After the load is switched on, it can be observed that the quantity of the harmonics produced under the “seamless transmission” is fewer than that under the “seamed transmission; and then, with the increase of the load within the rated current-carrying capacity of the cable, the quantity of the harmonics produced under the “seamed transmission” increases, whereas the quantity of the harmonics produced under the “seamless transmission” barely changes. A test on the ripple and noise components of a direct current shows that the amount of the ripples and noises produced under the “seamless transmission” is less than those produced under the “seamed transmission”. These experiments prove that, the traditional theory that the harmonics are mainly resulted from unbalanced grid transmission loads is incorrect, and that the seamed transmission is a major harmonic source and thus a ripple and noise source during the transmission of an alternating current or a direct current.

Through experiments, it is found and confirmed in the present application that the core wire structure of a cable is closely related with harmonics, and the seamed transmission is a major harmonic source and induces ripples and noises; and it is found and confirmed that a multi-core cable having core wires insulated from each other and a single-core cable fall within the range of seamless transmission, and both of them have a novel use of avoiding the harmonics, ripples and noises from being produced due to seamed transmission, and thus are novel technical solutions capable of completely eliminating the harmonic source, i.e., the seamed transmission.

(2) Electric energy waste is reduced.

One of the harms from the harmonics is electric energy waste as they are involved in electric energy metering but not contribute to the working of electric appliances.

A contrast experiment regarding the electricity saving capabilities of a cable enabling “seamless transmission” and a cable conducting “seamed transmission” is performed as follows: a traditional multi-core cable is adopted for the “seamed transmission”, whereas multiple enameled wires are adopted for the “seamless transmission”, where they both use copper core wires having the same cross-sectional area, a length of 60 meters and a number of 50; and the two cables alternately draw power, at one end thereof, from a same node in an AC network of 220 V and 50 Hz, an electric energy meter is provided at this node, and an electric stove is electrically connected at the other end of each of the cables of length of 60 m. The experiment shows that: if it is required to heat, through the two cables, a same amount of water to a same temperature, the heating time corresponding to the “seamless transmission” is shorter than that corresponding to the “seamed transmission” by more than 10%; and if the heating times for the both are the same, the water temperature reached under the “seamless transmission” is higher than that obtained under the “seamed transmission” by more than 10%. In repeating the contrast experiment multiple times each exhibiting the above two both 10% cases, the power consumption of the “seamless transmission” is substantially equal to the power consumption of the “seamed transmission”, whereas the effective powers of the two have a difference greater than 10%. The amounts of electric energy consumed by the two cables each are read at the input ends of the respective cables, and measured by the same electronic meter. It is showed by experiments that a single-core cable also has the effect of seamless transmission.

In another experiment where the experimental conditions are the same as the above but another electric stove behaving differently, which heats a same amount of water to a same temperature within a same period of time, is used, the current flow through the cable enabling “seamless transmission” is less than that flow through the cable conducting “seamed transmission” by more than 10%.

In the above-mentioned experiments, the more than 10% electric energy over-consumed by the seamed transmission is converted into harmonics, which are indeed in the first place of individual harmonic sources. This proves again that, the traditional theory that harmonics are mainly resulted from unbalanced grid loads is incorrect, and that the seamed transmission is the major harmonic source.

As for the above-mentioned experiments, no matter whether an inductive load (induction cooker) or a resistive load (resistance wire) is used, it can be verified and observed that the “seamless transmission” enables more than 10% of the energy to be saved, or enables the working time of an electric appliance to be reduced, or enables the working efficiency of the electric appliance to be improved, or enables electric energy waste to be reduced.

Another experiment shows that an electric motor can also benefit from the seamless transmission. For example, the rotation speed of the electric motor may be increased as a result of the seamless transmission.

Energy may also be saved on the electric energy input cable of the electric appliance. Although this cable is only one or two meters long, due to a large number of the core wires, a few percent points of electric energy would produce harmonics that are involved in the metering but not contribute to the working, and the amount of the saved energy varies with the size of the load.

The experiments show that the single-core cable also has the effect of seamless transmission.

It shall be indicated that the more than 10% electric energy saved through the “seamless transmission” as described in above-mentioned experiments actually corresponds to merely a part of harmonic components among the total electric energy, and it does not contain high-frequency harmonics that are attenuated at a distal end of the grid and thus do not arrive at the node where the power is supplied in the experiments. As the high-frequency harmonics will be attenuated with the increase of the transmission distance, this means that harmonics produced through the “seamed transmission” on the grid are attenuated along with their production. Thus, if the grid and the electricity related device both realize the “seamless transmission”, the energy saving effect of certainly will be improved. The amount of the saved energy for the direct current mainly depends on the residue of the alternating component therein.

The more than 10% electric energy saved through the seamless transmission is equivalent to the annual energy output of four Three Gorges Power Stations (the current annual energy output in China is more than four trillion kilowatt hours of electricity, and the annual energy output of the Three Gorges Power Station is one hundred billion kilowatt hours of electricity). In case of a same power, the energy saving principle of the present application is that, under the same power, the lower the voltage is, the larger the current is, and the more energy is saved. The voltage in countries like USA, Canada and Japan is 110 V. In theory, the amount the saved electricity energy under 110 V is twice as much as that under 220 V. The annual energy output worldwide is more than 20 trillion kilowatt hours of electricity. If all the grids and electricity related devices realize the “seamless transmission”, it is not difficult to calculate the economic, social and ecological benefits worldwide, which best explains the beneficial effect of the present application.

(3) The working quality of various electricity related devices may be improved at a low cost.

As for the CRT TV of a domestic brand, after all the multi-core cables of various lengths inside and outside the TV for transmitting electric energy and/or an electrical signal are replaced with generic enameled aluminum or copper wires, or single-core cables, the display quality is significantly improved, the contrast ratio is greatly promoted, the grey levels are obviously increased, the resolution of the image looks exquisite, and the colors become natural and vivid, not exaggerated and messy as they were. Even someone who is not a fan of video can see that the image quality has been significantly improved. After a CRT TV recognized as one having the highest level and the biggest size is modified in the same manner, it offers a significantly improved image quality when playing a same “blue-ray” video disc. After a full digital power amplifier with digital signal inputs is modified in the same manner so that the electric energy and/or electrical signal transmission cables and the output connection cables therein are replaced, the “digital sense” is greatly reduced. The three cases have the following common features: for both the external input and internal distribution of the electric energy and/or electrical signal of the electric appliance, the formerly used cables are replaces with cables enabling seamless transmission; and all the appliances are subjected to a long-term “burn-in” processing for 2,000 hours, and the performance of the appliances are still improved continuously after the 2,000 hours, while the general burning experience indicates that an appliance tends to have a stable performance once undergoing the burn-in processing for 200 hours.

The comparison result of a burn-in duration difference greater than 10 times reveals that the technical solution of the present application can inhibit harmonics, and ripples and noises induced from the harmonics, which are produced during the “seamed transmission” of the electric energy and/or electrical signal by an electricity related device itself, and which directly influence the quality; and it also reveals that the “seamless transmission” of the electricity related device will certainly improve the transmission quality of an analog signal and reduces the bit error rate of a digital signal; and it further confirms that a so-called “crystal grain boundary” or other undiscovered underlying phenomena that influence the transmission quality do exist in the internal structure of a conductor, and thus cause harmonics, ripples and noises, like a “short-circuit current” which steps over “crystal grains”, to be formed. The so-called “machine burn-in” and “cable burn-in” should be an aging treatment for optimizing the performance of cables under an interaction between a current and a conductor. In the traditional technical solution, after 200 hours, the harmonics produced through the “seamed transmission” begin to cover up underlying problems such as the crystal grains, and edge themselves into the electric energy and/or electrical signal, and influence the working quality of the electricity related device.

In order to improve the outgoing quality of an electricity related device, a corresponding technology for actively accelerating the aging of the electricity related device may be adopted during the manufacturing of the electricity related device.

Improvement of the transmission quality of the electric energy and the digital or analog electrical signals will inevitably result in the improvement in performance of various electricity related devices. Such an improvement may benefit various electricity related devices of all levels, with the only price of low-cost ordinary wires and insulating materials. In other words, the present application enables the quality of the electricity related device to be improved only at a low cost. In addition, after applying the seamless transmission to an electricity related device, the original filtering units may be reduced or simplified as appropriate so that they are only directed toward low-order harmonics, thereby reducing the manufacturing cost.

A particular mark for the improvement in the quality of the electricity related device is that the working quality of a traditional filtering device is improved. The traditional filter has inner and output cables realizing the “seamed transmission”, and thus the traditional filter itself produces new harmonics; in this case, the filtering effect of the traditional filter would definitely decrease as these newly produced harmonics are too close to the electricity related device. From this perspective, as long as the “seamed transmission” exists, a filter is still a harmonic source no matter how perfect it is. If the seamless transmission is realized, it is possible to prevent the harmonics from being produced by a filter itself, thereby improving the filtering quality.

Another particular mark for the improvement of the the quality of the electricity related device is that, the electricity related device has an improved efficiency, a more stable working state, a more reliable safety control and a longer working life, since heat, noise and vibration are less caused by the harmonics to the electric energy and/or electrical signal transmission network and to power utilization parts of the electricity related device, such as a transformer, an electric motor, a line and the electronic components.

(4) The electric energy transmission efficiency is improved.

According to the principle of skin effect, harmonics having a higher frequency tend to occupy the surface of conductor that is an excellent channel, thereby reducing the transmission efficiency; whereas with the seamless transmission which enables the harmonics to be avoided, it can regain this excellent channel, thereby improving the efficiency of electric energy transmission and saving electric energy.

(5) The use cost of electric energy is reduced.

Once the harmonics produced by the seamed transmission are eliminated, tasks in the electricity related industry, like harmonic suppression and even power factor and reactive compensation, are accordingly simplified, as a result that the use cost of electric energy is reduced.

In addition, the harmonics produced by the seamed transmission cause the excellent transmission channel, i.e. the surface of conductor to be wasted, whereas the seamless transmission enables the original transmission efficiency to be maintained under a relatively small wire diameter, thereby reducing wire waste.

(6) It is convenient for daily use.

An insulating paint like polyurethane is of strong adhesion, which causes a large paint removal workload when wire ends need to be connected. In industrial production, the problem of strong adhesion during the paint removal is easily solved by use of dedicated technologies and apparatuses, but it will be inconvenient if a dedicated tool is required in daily use. As for the technical solutions on core wire insulation provided in the present application, e.g. a multi-core cable has the core wire insulated in segments, a multi-core cable has bare and insulated core wires alternately collocated, an insulating paint or a wound insulating strip can be removed without any dedicated tool, making it convenient to join wire ends and connect a cable with an electric appliance.

(7) The filtering device is efficient, reliable and simple.

This device is manufactured according to the acknowledged principle that the energy of a high-frequency current would be attenuated with the increase of the transmission distance. Most harmonics are high-frequency currents, and thus would be attenuated with the increase of the transmission distance without exception. This device can overcome the disadvantages of existing filters and filtering circuits, such as new harmonic ripples produced by themselves, or limited power (especially transient power), or high costs. In one aspect, the device causes most harmonic ripples to be attenuated naturally during a transmission over a certain distance; and in another aspect, new harmonics produced by the core wires are actively avoided during filtration and outputting, as the “seamless transmission” is realized by using a multi-core cable with insulated core wires or a single-core cable. The device mainly solves the problem of high-order harmonics. Even if a unit for filtering out low-order harmonics based on the traditional technology is added, the structure of this device will not be complicated still.

(8) The effect of “shooting three birds with one stone” can be achieved at a low cost.

As for traditional technical solutions, the effects of all such solutions for harmonic suppression, improvement of the quality of the electricity related device and electric energy saving are restrained to the seamed transmission. The technical solutions of the present application achieves significant effects in all the three preceding fields, just by means of the seamless transmission which is a simple and low-cost measure, without any further additional technical features or technical solutions.

### BRIEF DESCRIPTION OF DRAWINGS

FIG. 1 is a schematic block diagram of a relatively typical structure for transmitting an electric energy and/or electrical signal of an electric appliance.

FIG. 2 is a schematic block diagram of a relatively typical transmission structure of an intermediate device for electric energy and/or an electrical signal.

FIG. 3 is a schematic block diagram of a relatively typical structure of a transmission network system.

FIG. 4 is a schematic block diagram of the structure of another transmission network system.

FIG. 5 is a schematic block diagram of the structure of a further transmission network system.

FIG. 6 is a schematic cross-sectional view of a multi-core cable having core wires insulated from each other in one transmission channel, including a number of core wires 1 respectively wrapped with an insulation layer and an insulation sleeve 2.

FIG. 7 is a schematic cross-sectional view of one core wire of a multi-core cable having core wires insulated from each other, where a core wire 3 made of a conductor is wrapped over a surface thereof with an insulation layer 4.

FIG. 8 is a schematic cross-sectional view of a multi-core cable having core wires insulated from each other in more than one transmission channels, where this cable is composed of a number of transmission channels 5 and an insulating cable sleeve 2, and the transmission channel is constituted by the multi-core cable having core wires insulated from each other.

FIG. 9 is a structural schematic diagram of one core wire of a multi-core cable which has insulation layers provided in segments, where the conductor 3 is wrapped over a surface thereof with insulation layers 4 of a certain length.

FIG. 10 is a schematic cross-sectional view of a multi-core cable having core wires with an insulation layer 6 and core wires without an insulation layer 7 alternately collocated.

FIG. 11 is a structural schematic diagram of a cable used for filtration, which includes an input end 8 having a relatively bigger wire diameter and an output end 9 having a relatively smaller wire diameter.

FIG. 12 is a schematic structural diagram of a filtering device, which includes a step-up transformer 10, a step-up transformer 11 and a filtering cable 12.

### DETAILED DESCRIPTION OF EMBODIMENTS

Hereinafter, embodiments of the technical solutions of the present application will be further described in conjunction with the drawings.

### Embodiment 1: A Novel Use of a Cable Structure Having Insulated Core Wires

Based on the harmonic source found and confirmed by the present application, the novel use of the cable structure having insulated core wires in the present embodiment is applicable within an electricity related area, from various electric generators, electric energy and/or electrical signal transmission networks and various intermediate devices, to the internals of all sorts of electric appliances or electric appliance systems, which enables the traditional “seamed transmission” for an AC or DC electric energy and/or electrical signal to be converted into “seamless transmission”, that is, it enables bad contact and a short-circuit current resulted from the seamed transmission to be eliminated. In addition, the multi-core cable having core wires uninsulated from each other as widely used in the traditional technology are replaced with an earphone multi-core cable structure having each core wire used for transmission insulated or with a single-core cable, even other core wires used for transmission made of an electrically conductive non-metallic compound conductor should also be insulated.

It is possible to keep the current in each core wire exactly on its own path just by simply treating the surface of each core wire used for transmission, for example coating it with an insulating paint or using other insulating materials or adopting other insulating manners, with the insulation grade determined as required; and accordingly, the harmonic source, i.e., the seamed transmission, may be eliminated, which enables harmonics caused by the “seamed transmission” and ripples and noises induced from the harmonics to be avoided. Insulation will not be necessary for core wires that are not intended for transmission, e.g. those for tensile and bending resistance.

The basic feature of the cable structure enabling seamless transmission for an electricity related device and a transmission network system is that core wires are insulated. The basic structure is shown in FIG. 7, in which a core wire 3 is made of a conductor, with an insulation layer 4 wrapped over the surface thereof. Furthermore, the core wire may be insulated in various ways.

All insulation solutions provided in the prior art may be taken as examples of the insulation solutions for the core wire in the present application. For example, the insulation is done with a metal oxide layer. For another example, the insulation may be done with scratch-free type (straight welded type) insulating paints containing polyurethanes and having various properties. But the insulating paint has one disadvantage regarding the paint removal workload at the time of cable connection, namely, the stronger the adhesion of an insulating paint is, the larger the paint removal workload is. Directed to this problem and as further depiction of the present embodiment, more examples of insulation solutions for the core wire are supplemented below:

Supplementary example 1 of the insulation solutions for the core wire: powders capable of insulating is implemented as the insulating material used for the multi-core cable having insulated core wires. Such insulating powders form an insulation layer between the core wires. The internal multiple core wires of a multi-core cable will be naturally separated from the insulating powders, once the outermost insulation layer of the multi-core cable is stripped off with a wire stripping plier.

Supplementary example 2 of the insulation solutions for the core wire: the insulating powders capable of insulating have a certain adhesion, with the size of this adhesion confined in such a manner that the insulation layer may be removed by simultaneously rubbing several core wires with fingers.

Supplementary example 3 of the insulation solutions for the core wire: formulations of the insulating paints used in traditional products, that are known for “poor quality”, weak adhesion, and easy removability just by rubbing with fingers or by finger nails, are used. Such an easily removable insulation layer for the core wire does not compromise the capability of the cable in avoiding the harmonics, as the cable is further provided with a peripheral insulation layer made of such as a plastic, which can prevent the core wires from moving around so that the insulation layers for the core wires can assure that the harmonics will be avoided in normal use.

Supplementary example 4 of the insulation solutions for the core wire: resin, gel and components with an similar function are added into the insulating paint, so that the paint intends to be pulverized and fragile after it forms a film, making it easy to remove the insulating paint by rubbing with fingers.

Supplementary example 5 of the insulation solutions for the core wire: in the insulating paint is added a chemical component which could decompose after a period of time and weaken the adhesion of the insulating paint. In production, the insulating paint may be adhered onto the core wire to facilitate the manufacture, and the adhesion decreases after a certain period of time, when using a multi-core cable having core wires insulated with such an insulting paint, a user may manually strip off the insulation layer, without using any dedicated tool.

Supplementary example 6 of the insulation solutions for the core wire: an insulating paint not tolerant to temperature is used, so that the insulation layer for the core wire may be removed just by heating.

Supplementary example 7 of the insulation solutions for the core wire: multiple core wires within the multi-core cable are respectively wrapped with materials, such as a soft strip-like or band-like insulation paper or film, so that a user can manually strip off the insulation layer when using such cables, without any dedicated tool.

Supplementary example 8 of the insulation solutions for the core wire: the core wires within the multi-core cable are treated twice. Specifically, these core wires are firstly wrapped with a material capable of releasing, and then coated with an insulating paint. With such a technology, the insulation layer may be easy to strip off, just like a coat.

Supplementary example 9 of the insulation solutions for the core wire: the insulation layer is provided in segments.

As shown in FIG. 9, the insulation layer 4 for the core wire within the multi-core cable ends after running axially along the multi-core cable for a certain length, followed by a bare metallic core wire 3 of a certain length, and then followed by the insulation layer 4 again. Within one multi-core cable, the bare segments and the insulation layers for each core wire have an identical length, with the bare segments of all the core wires adjacent to each other, so are the insulated segments. The insulation layers and the bare segments may respectively have any lengths, as long as both the insulating effect and the convenience for connection between wire ends may be guaranteed, for example, 10 millimeters of the bare segment, and 90 millimeter of the insulated segment and so on. The bare segments serve for joining.

Supplementary example 10 of the insulation solutions for the core wire: part or all of the multi-core cables traditionally used in the electricity related device are replaced with a single-core cable having a plastic insulation layer that is produced by a current technology, where a connection operation for such a single-core cable does not affect people's using habits. In order to improve the usability, a cable may be in the form of a spring by winding it around a spool, that is, similar to a connection cable between the transmitter and the body of a landline telephone.

Supplementary example 11 of the insulation solutions for the core wire: multiple single-core cables with a plastic insulation layer that are produced in accordance with a current technology are directly combined into one multi-core cable, where a connection operation for ends of this multi-core cable does not affect people's using habits.

Supplementary example 12 of the insulation solutions for the core wire: a wire is made of a plastic material, with multiple core wires packaged therein. The plastic material is easy to remove.

Supplementary example 13 of the insulation solutions for the core wire: a multi-core cable has bare and insulated core wires alternately collocated. As shown in FIG. 10, some core wires 6 are wrapped with an insulation layer, whereas some other core wires 7 are not wrapped with an insulation layer. By alternate collocation, they constitute a multi-core cable structure having all core wires insulated from each other. The core wires without the insulation layer make the workload on connection to be reduced.

Supplementary example 14 of the insulation solutions for the core wire: a mature electrostatic spraying technology is used to form an insulation layer on the core wire.

Supplementary example 15 of the insulation solutions for the core wire: a mature oxidization insulation technology is used to form an insulation layer on the core wire.

Supplementary example 16 of the insulation solutions for the core wire: a positioning device is used to form a spatial distance between the bare core wires.

The above-mentioned supplementary examples may improve the usability of the multi-core cable having core wires insulated from each other, and make it easy to join wire ends and connect a wire end with a connecting terminal of an electricity related device.

On the basis of achieving transmission purpose and core wire insulation, the cable structure enabling seamless transmission further has the following subsidiary features:

The seamless transmission has no special requirement on conductor materials. It is experimentally verified in the present application that harmonics produced in a multi-core cable may be avoided by mutual insulation between the core wires rather than the nature of a conductor material, and thus the original selection criteria for the conductor material may remain as it is, or even be lowered. The harmonics resulted from the seamed transmission may be avoided only when the individual core wires used for transmission each are insulted, no matter whether thus core wires are made of a high-end conductor, such as silver, superconducting material or single crystalline conductor, or made of copper, aluminum or an alloy, with no exception. In addition, the core wires within one of the multi-core cables may be conductors of a same material, or conductors of two or more different materials, or conductor materials of two or more of the multi-core cables may be different from each other. As a subsidiary structure of the cable, some of the individual core wires of the multi-core transmission cables may be made of any material so as to be uninsulated, and the uninsulated core wires are configured for purposes other than transmitting the electric energy and/or electrical signal.

A subsidiary unit is added. For example, one end or both ends of the cable is provided with a plug connector, and the plug connector is configured for connection with individual units within an electricity related device having a corresponding plug connector, or for connection with an electricity related device having a corresponding plug connector; and the multi-core cable is provided with a shielding layer, a vibration reducing layer or a filtering magnetic ring, or the multi-core cable has one or more transmission channels and is free of a peripheral insulation layer.

All the core wires of one cable have a same diameter. The diameter of each core wire may be determined as in the traditional technology, or as required by an object to be transmitted, that is, both a large diameter and a small diameter are acceptable. Moreover, among the core wires, there may also be any number of core wires with different diameters.

Both the multi-core cable constituted by multiple core wires collocated together and each of the core wires may have a cross section in any geometrical shape, e.g. circular, elliptical, hollow annular, hollow discontinuous annular and flat.

The seamless transmission has no requirement on whether the core wires of a multi-core cable are stranded or not. Multiple core wires may be stranded to form one transmission channel; or multiple core wires of the multi-core transmission cable are linearly collocated without being stranded, to form one transmission channel; or multiple core wires are in different lengths, with part of the multiple core wires stranded and the remaining being linear, and the stranded and the linear wires forming one transmission channel.

The number of the core wires within the multi-core cable may be determined as in the traditional technology, or as required by an object to be transmitted.

As for a multi-core cable having core wires insulated from each other, the peripheral insulation layer may not be provided therefor as the core wires are already insulated. Of course, it can also be done as the traditional technology, depending on usage requirements.

Besides the above-mentioned multi-core cable having core wires insulated from each other, the seamless transmission may also be realized with a single-core cable. The single-core cable has a disadvantage of poor flexibility, but the flexibility may be improved by winding the single-core cable to form a tubular cable of a spring structure, just like the transmitter connection wire of a landline telephone. Although this costs more consumables, a certain filtering effect may be achieved (see the following filter). A multi-core cable having a relatively poor flexibility may also be wound to form a tubular cable.

The requirement on manufacturing the multi-core cable with insulated core wires necessary for the seamless transmission is less strict. As long as the transmitted current is restrained from stepping over a gap between the core wires, the insulating materials, insulation modes and production technology for the core wires may be selected arbitrarily and may vary in any way.

If the multi-core cable enabling seamless transmission is used, the joining of its wire ends or its connection with a connecting terminal of an electricity related device may be done with any solution in the traditional technology, e.g. by use of a plug connector, a hinged connection, welding, riveting, glue, screws, bolts and nuts, once the insulation is removed. As in the traditional technology, a direct-welded type insulating paint enables the insulation to be removed simultaneously with the connection.

The seamless transmission does not have a single adverse effect on the quality of electric energy and/or an electrical signal, nor does it bring any negative influence to the original performance, usage and the like of an electricity related device. As for safety, the insulation for the core wires enhances the safety of the multi-core cable.

Compared with the seamed transmission, the seamless transmission has an instant energy saving effect, but the remarkable effect regarding quality will not show until the wire has been aged for a certain period of time. The more the aging degree of a cable is, the more the harmonics and ripples and noises induced from the harmonics vanish, and the higher the transmission quality of the electric energy and/or electrical signal is. For example, the quality of the TVs and the digital power amplifier is still improved continuously even after 2,000 hours of aging by natural use, as described above. In order to improve the outgoing quality of products, the cables may be subjected to an aging treatment during the manufacture of electricity related devices. A cable may be aged with an alternating or direct current having different frequencies and different sizes which pass through the cable separately or alternately, or the aging may be accelerated by means of a large temperature change of the environment or the cable while the cable is energized.

The effect of seamless transmission depends on the number of the cables being replaced. Multi-core cables required for transmission in the traditional technology may all be replaced to have core wires enabling seamless transmission, so as to obtain the best effect; alternatively, only a part of them may be replaced, or even the seamless transmission may be realized only in one or more long or short cables, to obtain a certain effect. All these as mentioned above fall within the scope of protection of the present application.

Certain terms in the present application documents have the following meanings:

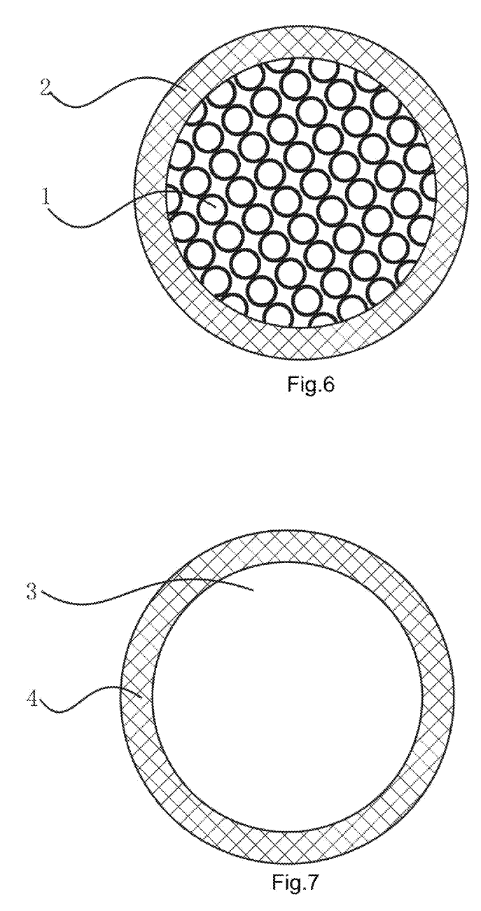

The term “wire” as used in the present application has the same meaning with terms such as electric cable, electric wire, cable, conductor, wire cable, transmission wire, connection wire, jump wire and jumper. A single-core cable is distinguished from a multi-core cable based on the number of metallic core wires constituting one transmission channel. Specifically, a cable for which one transmission channel is constituted by two or more core wires is a multi-core cable, and a cable for which one transmission channel is constituted by one core wire is a single-core cable. Experiments show that both the cable structures, i.e. the single-core cable and the multi-core cable having core wires insulated from each other, have the same effect of avoiding harmonics. In the present application, the single-core wire refers to a cable having only one core wire, whereas the multi-core cable refers to a cable for which two or more core wires are gathered together to form one transmission channel. Under the same wire diameter, the single-core cable has a relatively poorer flexibility. Thus, multi-core cables are widely applied to various electricity related devices. As shown in FIGS. 6, 7 and 8, the core wire 3 is made of a conductor, and then wrapped with an insulation layer 4. Thus, it may be used as a single-core cable, or several such core wires wrapped with an insulation layer may be combined as a multi-core cable enabling seamless transmission.

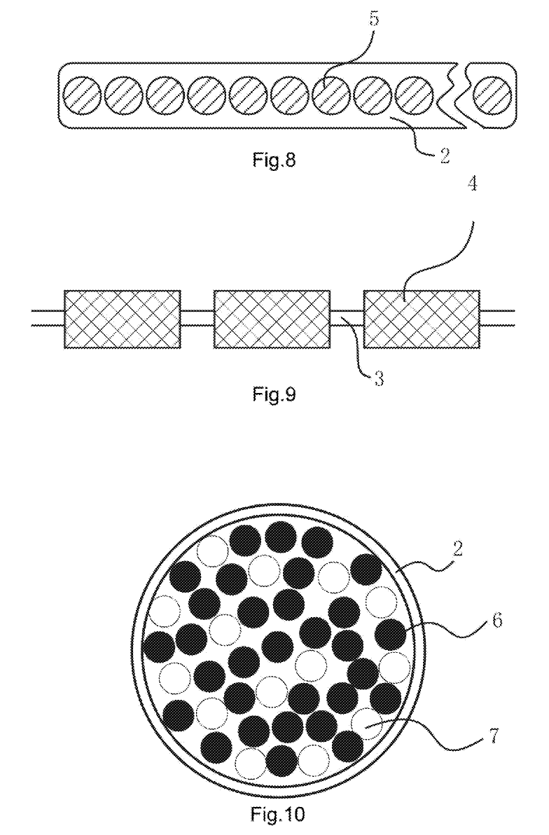

The multi-core cable may have many kinds of structures in which: multiple core wires are stranded or un-stranded; several single-core cables, although being dispersive in pattern, are practically used commonly as one transmission channel; and Milliken conductors for one transmission channel are constituted in such a manner that multiple groups are firstly formed with each group constituted by multiple core wires uninsulated from each other, and then the multiple groups are collocated and insulated from each other. Besides a conductor core wire used for transmission purpose which is used as the main body of the cable, the multi-core cable may have cable accessories for other purposes, e.g. a tensile resistant core wire, a shielding layer, a magnetic ring, a shock-proof material, a filler, a fixture, an insulation layer and a plug connector. These cable structures may be named as for example twisted pair, flat cable, VGA cable, USB cable, HDMI cable, signal transmission cable and electric cable, among which some have only one transmission channel for one cable, and some have two or more transmission channels for one cable, but they all fall within the range of multi-core wires or multi-core cables or multi-core transmission cables as described in the present application. The structure as shown in FIG. 8 is a multi-core cable constituted by several transmission channels 5 and an insulating sleeve 2, in which each transmission channel is constituted by multiple core wires insulated from each other.

The term “harmonic” as described in the present application further includes ripples and noises, in addition to harmonics, if the ripples and noises induced from the harmonics exist in the electric energy and/or electrical signal being transmitted.

The term “current” as described in the present application refers to electric energy and/or an electrical signal.

The term “electric energy” as described in the present application includes: an AC or DC electric energy of different frequencies that are transmitted or transformed within a grid and an electricity related device; an AC or DC electric energy obtained through self-power-generation by a mains end user with oil or other energy resources; an uninterrupted power supply (UPS); a battery; and the like.

The term “electrical signal” as described in the present application refers to a current already loaded with information, including low and high frequency signals, audio and video signals, analog and digital signals, sine wave and square-wave signals, alternating current and direct current signals and the like, which are classified from different perspectives.

The expressions “in an insulated state”, “insulated from each other” or “insulated” regarding the core wires as described in the present application do not mean that each of the core wires requires an insulation layer. As shown in FIG. 10, if the solution where core wires without an insulation layer 7 and core wires with an insulation layer 6 are alternately collocated is used for a multi-core cable, the individual core wires of the multi-core cable are in an insulated state, as bare core wires, though without an insulation layer, are separated by those core wires with an insulation layer. The insulating strength of the core wire as required by the seamless transmission depends on the requirements of different objects to be transmitted, with the basic requirement that the object being transmitted is completely precluded from stepping over a gap between the core wires.

The technical features of the present embodiment are also applicable to the following embodiments.

### Embodiment 2: Electricity Related Device

The term “electricity related device” refers to, other than electric energy and/or electrical signal transmission network systems, all devices involving electric energy and/or an electrical signal, including an electric generator, electric energy and/or an electrical signal control device, an electric appliance (a loudspeaker, a voice box, a carrying tool, a production apparatus, a medical apparatus, a household electric appliance and a wireless transmission system), an intermediate device etc. In the present application documents, the term “electricity related device” refers to not only an independent device having a single function, but also a system composed of more than two independent devices, e.g. a car.

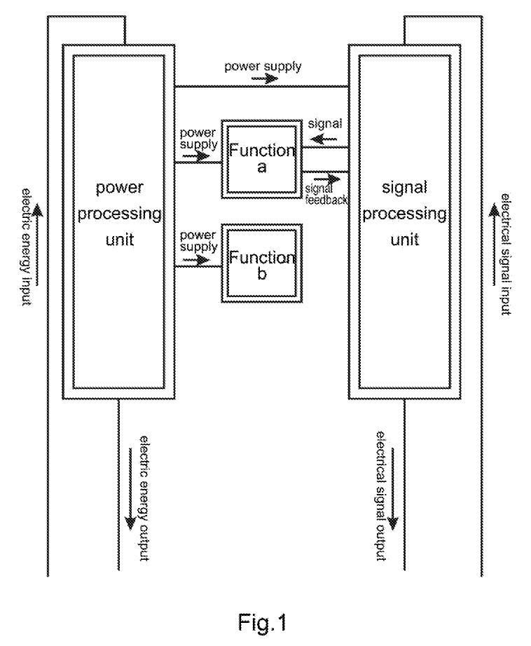

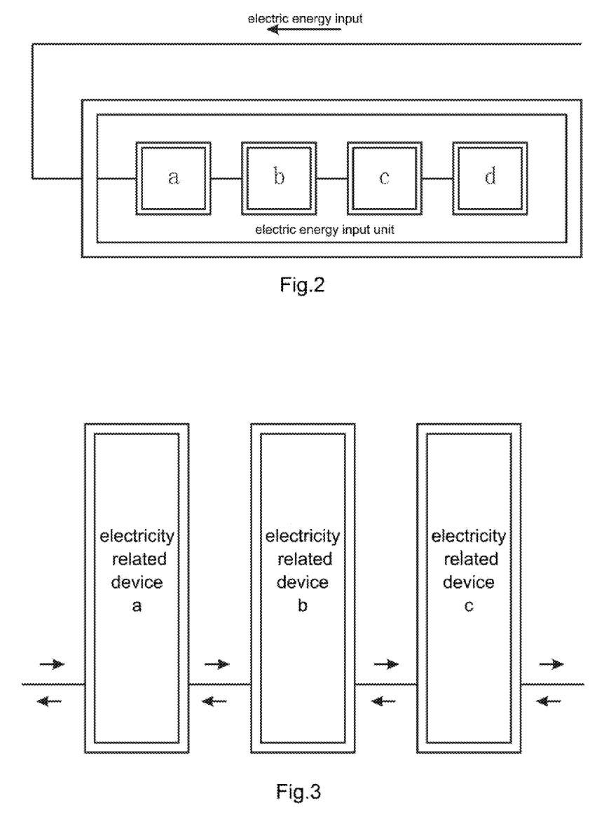

The electricity related device as shown in FIG. 1 and the electric energy and/or electrical signal distribution device as shown in FIG. 2 are merely exemplary. Referring to FIG. 1, after electric energy is input, it passes through a transformer or a switching power supply or an intelligent power processing unit, to supply designated voltages and currents respectively to a signal processing unit and functional units a and b, and to output a designated voltage and current to the outside. In this case, functional unit a receives a signal from the signal processing unit and feeds back a signal to the signal processing unit, thereby fulfilling its function, whereas functional unit b only consumes the electric energy, for example, it may be a power indicator. Specific electricity related devices may have many variants and wide varieties. It may only have functions a and b as shown in FIG. 1, or only one function as shown in FIG. 2, or have several other functions, or have further more kinds of transmission cables, or only have one or two kinds of cables as shown in FIG. 2. The electricity related device as shown in FIG. 1 includes external electric energy input and output cables, an internal electric energy transmission cable, an external signal input and output cables, and an internal signal transmission cable. These cables generally adopt various types of multi-core cables having core wires uninsulated from each other, and they are either fixedly connected with an electricity related device, or form an independent one if being connected through a plug device, e.g. they may form a flat cable. Any electricity related device can use the multi-core cable having core wires insulated from each other for part or all of the cables used in this device, despite their lengths, how many channels they have, what they transmit or how the flow is, so as to avoid harmonics from being produced by the seamed transmission, save electric energy, and improve the working quality.

For further features of the technical solution in which the core wires are insulated from each other in the present embodiment, reference may be made to embodiment 1 which constitutes a part of the present embodiment.

### Embodiment 3: Power Generating Apparatus

A power generating apparatus is an electricity related device, which includes all devices that transform energies in other forms into electric energy. As for the power generating apparatus, it is not confined in terms of the structures thereof, that is, it may be one equipped with an automatic signal control device, or a common automotive generator; it is not confined in terms of the generated power, that is, it may range from a high-rating generator in a power plant or a power station to a mini generator of a few watts, and to an even smaller hand generator; and it is not confined in terms of the circumstances under which it is used, that is, it may range from a stationary generator set to a mobile automotive generator. If they partially or entirely use multi-core cables having core wires insulated from each other, it is possible to avoid harmonics from being produced by the seamed transmission and improve their power generating efficiency and working quality.

For further features of the technical solution in which the core wires are insulated from each other in the present embodiment, reference may be made to embodiment 1 which constitute a part of the present embodiment.

### Embodiment 4: Electrical Appliance

An electrical appliance is an electricity related device. It is a terminal of electric energy and/or electrical signals, and includes all devices which fulfill their own specific functions by consuming and utilizing electric energy and/or electrical signals, e.g. a great variety of machine tools, instruments and meters, induction heaters, electric smelting furnaces, radars, elevators, robots, monitoring devices, luminaire, medical appliances and household appliances. Such devices could either be an electric appliance having a single function, or an electric appliance system which is composed of multiple electric appliances and has a single or multiple functions.

Various kinds of multi-core cables used for transmitting electric energy and/or electrical signals between electric appliances or within an electric appliance itself are very important, because although harmonics coming from afar would be attenuated in some extent, multi-core cables having bare core wires that are close to the electric appliance or used within the electric appliance produces new harmonics, which not only waste electric energy accompanied by production of heat, but also further induce ripples and noises, which influence the quality of electric energy and/or electrical signals and are so fierce that they directly influences the performance of the electric appliance, as proved in the experiments. In the present embodiment, multi-core cables having core wires insulated from each other or single-core wires are adopted for part or all of electric energy and/or electrical signal transmission paths between electric appliances and within an electric appliance itself.

Taking a smelting furnace as an example, no matter what type the smelting furnace is, the cable for power distribution has a certain length, and its normal state is to transmit electric energy with full load. In such a case where there is a long path and a high current with full load, traditional multi-core cables are highly prone to producing a great amount of harmonics, which waste electric energy. A considerable energy saving efficiency may be obtained just by replacing more than one cables therein with cables having core wires insulated from each other.

Taking a traditional common audio power amplifier and a TV as an example, they use at many positions multi-core cables having core wires uninsulated from each other to transmit electric energy and/or electrical signals, for such as power supply (transformer) management and distribution, audio source management and distribution, connection for individual units, connection for various control and display components, input and output connection for electric energy and/or electrical signals. In such a case, there may be a jumper as a single transmission channel, or a flat cable having multiple collocated transmission channels, or other multi-core cables which are provided as required and have USB and HDMI cables for input and output. If they are partially or entirely replaced with multi-core cables having core wires insulated from each other or single-core cables, the playback quality may be improved.

Taking an air conditioner as an example, it adopts at multiple positions multi-core cables having core wires uninsulated from each other to transmit electric energy and/or electrical signals. If such cables are replaced partially or entirely to adopt the above insulation solutions for the core wires, harmonics may be reduced, thus reducing heat from the cables, noises and the electric motor, reducing faults, and prolonging the lifetime, and saving electric energy.

Taking a camera type medical endoscope as an example, it adopts at multiple positions multi-core cables having core wires uninsulated from each other to transmit electric energy and/or electrical signals. If the multi-core cables of a master machine, for example, a connection cable between a camera and the master machine, and for another example, a connection cable between a receiving end of a wireless capsule endoscope and the master machine, are partially or entirely replaced with multi-core cables having core wires insulated from each other, it is possible to improve the image quality and provide more image details. For an medical endoscope, this means higher possibility of discovering more clues to diseases, or means finer surgical procedures.

Taking an electric welding machine as an example, it is a low voltage and high current electric appliance, with a large wire diameter and a relatively long transmission distance. If using multi-core cables which has core wires insulated from each other and enables seamless transmission, the electric welding machine may show a more significant energy saving effect.

Taking a loudspeaker and a microphone as an example, both of them are electric appliances. Regardless of their size, they all have connection cables between a connecting terminal and pickup and sound production parts, which may be replaced with multi-core cables having core wires insulated from each other. Although such cables are not long, newly noises produced by bare core wires would influence the sound quality without attenuation, as these cables are close to the pickup and sound production parts. A high current woofer is more prone to such influence. Though an earphone speaker has a low current, the damage from a small amount of fresh noises would easily compromise the listening experience, as it is used near ears. It is worse for mid- and high-end earphones. An electrostatic loudspeaker requires an external power supply and a large current, and thus produces a high noise; however, if the fresh noise is removed, its original low distortion rate could be further decreased.

Taking a Hi-Fi audio as an example, one of the features of high fidelity is that the signal source, the amplifier and the voice box are separated. From a general view about the current status of research on Hi-Fi transmission cables, the focus is on the connection cables between the instruments, rather than on the transmission cables inside the instrument. It is experimentally proved that new noises produced by a transmission cables inside the instrument would have a direct influence on the playback effect. As long as part or all of the multi-core cables within each instrument, including those used for electric energy and/or electrical signals, and for audio input and management, especially those from the connecting terminal of the voice box to the terminal of the loudspeaker and those from the terminal of the loudspeaker to the sound production parts of the loudspeaker which are ignored previously, are replaced with the multi-core cables having core wires insulated from each other and made of an ordinary material, it is possible to substantially improve the audio performance once the cables are aged, so as to obtain a more natural and realistic replay effect compared with the case where the multi-core cables having bare core wires are used. It is additionally indicated that the reason a speaker cable being particular about materials lies in that a good transmission performance of a conductor enables a short circuit current resulted from the seamed transmission to be reduced; and the reason for selecting a large diameter lies in that it is necessary to make a high current, when being transmitted, still appear to be a small load for an extremely large wire diameter, which may also enable harmonics resulted from a wire-to-wire short circuit between bare core wires to be reduced. However, the seamless transmission does not require a large wire diameter, nor does it require a particular material.

A common voice box may be seen everywhere, e.g. beside a computer, on a desk, inside a car, built-in a TV, in a cinema, in indoor and outdoor performance venues, and background music players, and the list goes on. Due to cost control, they either have no filtering capacity, or have an extremely limited filtering capacity, and thus suffer from great extraneous interference; in addition, they further suffer from harmonics newly produced by the seamed transmission as disclosed in the present application, the original solution of low cost fails to achieve a good effect. Seamless transmission may be applied to part or all of them, so as to achieve a higher cost performance at a low cost.

Taking a numerically-controlled modular machine tool as an example, it integrates and controls a plurality of components by means of various multi-core transmission cables for electric energy and/or electrical signals. If part or all of these transmission cables are replaced with the multi-core cables having core wires insulated from each other, that is, if the solution of seamless transmission is adopted, it is possible to improve the quality of the numerically-controlled machine tool in terms of energy consumption, accuracy and reliability.

For further features of the technical solution in which the core wires are insulated from each other in the present embodiment, reference may be made to embodiment 1 which constitute a part of the present embodiment.

### Embodiment 5: Carrying Tool

In the present application, sea, land and air transport devices for carrying people or things are all carrying tools, and also belong to electricity related devices. A carrying tool is an independent system, and many sub-systems thereof are electric appliances, e.g. an electric energy driving system, a fuel ignition system, an autopilot system, a navigation system, a window lifting system, a communication system, a monitoring system, and a lighting system, and furthermore, each sub-system further includes several electric appliances. The carrying tool is either equipped with its own power supply, or carries various types of batteries or power generating devices utilizing various energies. The point about applying the seamless transmission to the entire system of the carrying tool, including the smallest electric appliance therein, is that it saves electric energy, improves the endurance capability, improves the electric energy and/or electrical signal transmission quality and the working quality of electric appliances, and increases the safety factor.

For further features of the technical solution in which the core wires are insulated from each other in the present embodiment, reference may be made to embodiment 1 which constitutes a part of the present embodiment.

### Embodiment 6: Wireless Transmission System

The range of application of wireless transmission keeps extending. Specifically, remote control devices, wireless internet of things and long-distance wireless meter reading have become reality, and a smart home solution is also achieved under a wireless mode. In addition, the object to be transmitted is currently extended from an electrical signal to electric energy. Wireless transmitting and receiving ends also are electricity related devices, and they also have multi-core cables. If the seamed transmission is applied, harmonic interference would be produced which compromises the transmitting or receiving quality. In view of this, the wireless transmitting and receiving ends may be partly or entirely applied therein with the seamless transmission.

For further features of the technical solution in which the core wires are insulated from each other in the present embodiment, reference may be made to embodiment 1 which constitutes a part of the present embodiment.

### Embodiment 7: Intermediate Device

An intermediate device is defined in the present application documents as various devices between electric energy and/or electrical signals and an electric appliance, which do not use the electric energy and/or electrical signals themselves and serve the electric appliance. They are electricity related devices.

Main functions of the intermediate device include for example continuation, conversion, relay, switching, distribution or control of electric energy and/or electrical signals. The intermediate device could be, for example, an energy storage station, a large-scale or micro charging device, an electricity storage device, a transformer substation, a converter station, a converter, a transformer, a connector, various connection cables, a coupler, a transducer, an inverter, a rectifier, a filter, a reactive power compensation device, a combined device connecting the mains electricity and receptacle power socket of an electric appliance, an electric energy and/or electrical signal distributor, an electric energy and/or electrical signal control system, an electric energy and/or electrical signal pivot system.

As for an intermediate device using multi-core cables, if the seamless transmission solution is adopted for part or all of thus multi-core cables, it is possible to avoid the harmonics produced by the device itself from mixing with the electric energy and/or electrical signals being processed by the device.

Taking an independent filter as an example, it is responsible for filtration. If its power output cable or a connection cable from a filtering unit to an output terminal adopts the seamed transmission, even an extremely good filtering quality would be compromised, whereas adopting the seamless transmission can gain beneficial effects.

Taking a charger as an example, if the seamless transmission is applied to the input and output of a charger for e.g. a cellphone, a portable electric appliance, an electric bicycle and an electric automobile, electric energy can be saved.

Taking a power socket as an example, as shown in FIG. 2, it has one or more output interfaces a through d, and draws power from the grid via multi-core power cables having a length of 1 meter to several meters. When a nominal current passes through the power cable of the socket, the seamed transmission would cause several percent points of electric energy to become harmonics, which is a waste of electric energy. If the current is below the nominal standard, still, the seamed transmission would result in a certain amount of harmonics, and these harmonics would has the most influence on the working quality of an electric appliance as they are closest to the electric appliance. Moreover, when there is a current passing through the cable of the socket, the harmonics produced by the seamed transmission cause the surface of the core wire, which is an excellent transmission channel, to be wasted. Thus, if the solution of seamless transmission is applied for the power input cable of the socket itself and the multi-core cables within the socket, it is possible to avoid the harmonics and save electric energy, and furthermore, it is possible to regain the transmission channel on the surface of the core wire, which is previously occupied by the harmonics, reduce heat production, provide a more reliable safety control or maintain the original transmission efficiency with a relatively small wire diameter, and to reduce wires consumed by the socket.

For further features of the technical solution in which the core wires are insulated from each other in the present specific embodiment, reference may be made to embodiment 1 which constitutes a part of the present specific embodiment.

### Embodiment 8: Filtering Device

Most harmonic components in electric energy and/or electrical signals are high-frequency currents. The present device is manufactured according to the acknowledged principle that the energy of a high-frequency current will be attenuated with the increase of the transmission distance, with the feature that the current is made to pass through a cable of a certain length after the electric energy and/or electrical signal is input, and then is output after high-order harmonics are attenuated in some extent. The length of the cable of the filter for attenuating the high-frequency current depends on the degree of contamination of the electrical signal of the power supply and the requirements of the electric appliance. Specifically, the higher the desired purity of the electrical signal of the power supply is, the longer the length of the cable used for filtration is. Generally, a transmission distance of 50 cm can just show a filtering effect. This device may be made as an independent device external to an electric appliance; alternatively, one or more units may be provided inside the electric appliance, in this case, an input cable of a certain length may be provided ahead of an input end of a certain unit in the electric appliance which requires an relatively pure electric energy and/or electrical signal. Such cables may be brought together in various ways, so as to save and adapt to the space in which they are located, and the conductor of the cable can be made of any material.

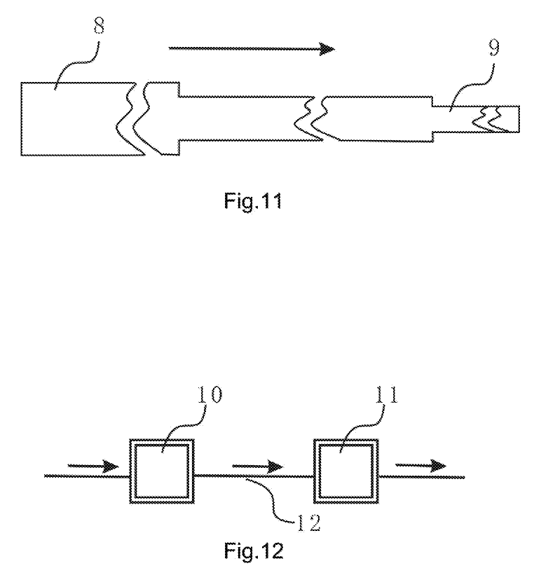

If a solution where attenuation and filtration are realized under a long distance of over 10 meters is adopted, two structures respectively having a varying diameter and a varying voltage may be used, in order to assure a nominal current, save wires and reduce the size of the filter. The varying diameter means that the input end of the cable is provided with a diameter required by a current higher than the nominal current. As shown in FIG. 11, the diameter of the output end is just the diameter required by the nominal current. This means that the diameter of the input end 8 is larger than that of the output end 9. Thus, a nominal current-carrying capacity may be guaranteed, and the material for cable may also be reduced. As shown in FIG. 12, the varying voltage means that a step-up transformer 10 is provided at the input end for stepping-up the current, and a step-down transformer 11 is provided at the output end for stepping-down the voltage. Provision of such step-up and step-down transformers enables the diameter of the cable 12 used for filtration to be reduced, thus reducing the size of the filter and the material consumed by the cable.

The multi-core wire having core wires insulated from each other or a single-core wire is used as the cable of this device. Besides the option of the technical features relative to core wire insulation in the present application, reference may also be made to the structure of a transformer for the insulation method, to learn from the principle that the transformer uses an insulation oil. Manufacturing a filter using such an insulation method not only reduces the size of the filter, but also makes it easy for heat radiation.

The main function of the device is to make high-order harmonics naturally attenuated. Such device can be combined with the prior art directed toward low-order harmonics, for achieving high-quality electric energy and/or electrical signals.

This device overcomes the disadvantages of existing filters and filtering circuits, such as new harmonics produced by themselves, or limited power (especially transient power), or high costs. This device makes original harmonics from the grid naturally attenuated during the “seamless transmission” over a specific distance, and both the filtering process and output produce no new harmonics.

For further features of the technical solution in which the core wires are insulated from each other in the present embodiment, reference may be made to embodiment 1 which constitutes a part of the present embodiment.

### Embodiment 9: AC and/or DC Electric Enemy Transmission Network System

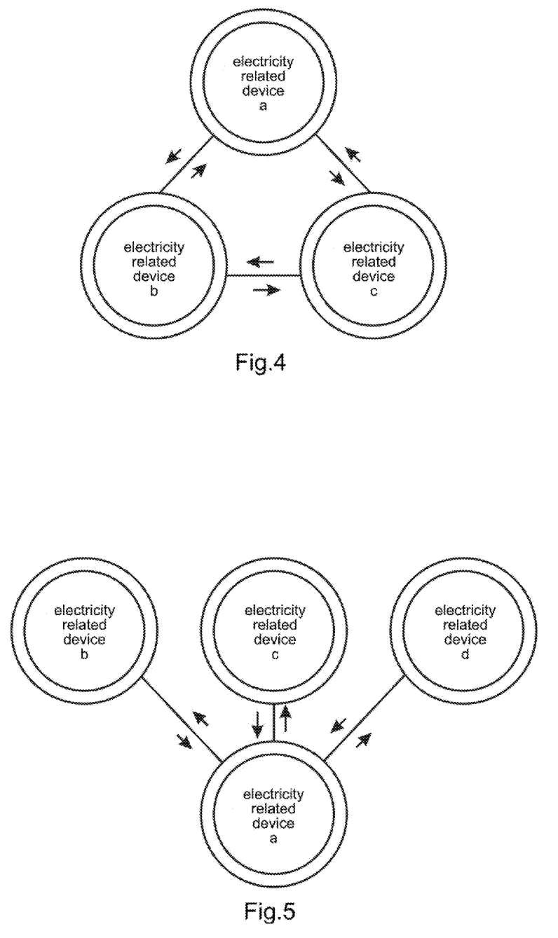

An electric energy transmission network system in the present application documents refers to a network having a long transmission distance of over 3 meters and more than 3 electricity related devices connected through multi-core cables. The structure of such a network has at least the types as shown in FIGS. 3, 4 and 5. As shown in FIG. 3, the electricity related devices are connected one by one. As shown in FIG. 4, the electricity related devices are connected a closed loop form. As shown in FIG. 5, the electricity related devices are connected in a tree form. They can be used to transmit simply electric energy or along with an electrical signal. The transmission direction can be one-way or two-way or both of them.

The object to be transmitted by the electric energy transmission network system is an AC and/or DC electric energy, involving ultra-high voltage power transmission, high voltage power transmission, medium voltage power transmission and low voltage power transmission, etc. In the present application documents, a high voltage transmission network system is an electric energy transmission network system from an electric generator to a transformer nearest to a user who needs the electric energy. A low voltage transmission network system is defined in the present application as a low voltage distribution network system from a transformer, which is at the very end of the network and nearest a user who needs the electric energy, to various electric appliances of the user.

Among the transmission paths between an electric generator, a power supply and a terminal electric appliance, there are a pure alternating current transmission network, a pure direct current transmission network, and a network in which an alternating current network and a direct current network are used in mixture.

Part of all of the traditional multi-core cables as used in a large amount in a traditional power transmission system may be replaced with those realizing seamless transmission, which provide the effects of avoiding harmonics and the harms thereof, provide pure electric energy, reduce wire losses, reduce faults and accidents of the system itself, reduce filtering devices, lower operation costs, and provide a purified channel for power line carrier communication, remote meter reading and home intelligent systems.

The seamless transmission produces different energy saving effects in high voltage and low voltage transmission network systems. The reason lies in that, under the same flow, the amounts of current converted into harmonics in both the high voltage and low voltage transmission network systems are substantially equal, this current part has a higher percentage in the total electricity amount as transmitted in the low voltage transmission network system than in the high voltage transmission network system, and hence, it is the low voltage transformer power transmission and distribution network near an electric appliance that has a more significant energy saving effect. Based on the same reason, the energy saving effect of a network at 110 V is better than that of a network at 220 V.

For further features of the technical solution in which the core wires are insulated from each other in the present embodiment, reference may be made to embodiment 1 which constitute a part of the present specific embodiment.

### Embodiment 10: Electrical Signal Transmission Network System

An electrical signal transmission network system in the present application documents refers to a network having a long transmission distance of over 3 meters, and more than 3 electricity related devices connected through multi-core cables. Along the transmission paths, there are both wireless devices and wired devices. For example, the electrical signal transmission networks may be used for such as mobile communication servicing cellphone users, intelligent devices, numerically-controlled modular machine tools, medical diagnostic devices, live sound reinforcement, live telecasting, studios, audio-video monitoring, computer rooms, multimedia control systems, telecommunication systems and monitoring systems composed of a plurality of sensors.

The structure of the electrical signal transmission network system has at least the types as shown in FIGS. 3, 4 and 5. As shown in FIG. 3, the electricity related devices are connected one by one. As shown in FIG. 4, the electricity related devices are connected a closed loop form. As shown in FIG. 5, the electricity related devices are connected in a tree form. They can be used to transmit simply electric energy or along with an electrical signal. The transmission direction can be one-way or two-way or both of them.

For further features of the technical solution in which the core wires are insulated from each other in the present embodiment, reference may be made to embodiment 1 which constitutes a part of the present embodiment.

1. A usage method of a cable structure having insulated core wires, wherein the cable structure is configured to avoid harmonics, ripples and noises produced by use of a solution of seamed transmission of electric energy and/or an electrical signal; or configured to avoid electric energy waste caused by the harmonics, ripples and noises produced by the seamed transmission of the electric energy and/or electrical signal; or configured to avoid the harmonics, ripples and noises produced by the seamed transmission of the electric energy and/or electrical signal from influencing a working quality of an electricity related device and a working quality of an electric energy and/or electrical signal transmission network system.

2. The usage method of a cable structure having insulated core wires according to claim 1, wherein the cable structure is configured to transmit and distribute electric energy within the electricity related device, or configured to input or output electric energy to or from the electricity related device, or configured to transmit an electrical signal within the electricity related device, or configured to input or output an electrical signal to or from the electricity related device, or applicable to a high voltage AC electric energy transmission network system, or applicable to a low voltage AC electric energy transmission network system, or applicable to a DC electric energy transmission network system, or applicable to an electrical signal transmission network system, or applicable to manufacturing multi-core transmission cables of various types and various specifications that are adapted to different voltages and different flows and enable seamless transmission of the electric energy and/or electrical signal.

3. The usage method of a cable structure having insulated core wires according to claim 1 or 2, wherein the cable structure having insulated core wires comprises one or more transmission channels constituted by multi-core cables, or comprises one or more transmission channels constituted by single-core cables, or comprises more than two transmission channels constitute by multi-core cables and single-core cables in combination.

4. An electricity related device, which is not earphones, the electricity related device comprising multi-core transmission cables for transmitting and distributing electric energy within the electricity related device, inputting external electric energy, outputting electric energy, transmitting an electrical signal internally, inputting an external electrical signal, or outputting an electrical signal, wherein one or part or all of the multi-core transmission cables have individual core wires used for transmission insulated from each other, with the core wires used for transmission provided in the multi-core transmission cables.

5. The electricity related device according to claim 4, wherein within the multi-core cable used in the electricity related device, individual core wires used for transmission are insulated from each other by adopting an insulation solution, in which surfaces of the core wires are coated with an insulating paint, or wrapped with an oxide insulation layer, or wrapped with an electrostatic coating; or insulated segments and bare wire segments are provided alternately, or bare core wires and insulated core wires are arranged alternately; or the core wires are wound with a strip-like insulator, or wrapped with a powder insulation layer, or wrapped with a release layer and an insulation layer; or a wrapped insulation layer falls off automatically after a period of time, or falls off when being rubbed by a finger; or a positioning device is used to form a spatial distance between the core wires.

6. The electricity related device according to claim 5, wherein the insulating paint is polyurethane, or a main component of the insulating paint comprises polyurethane.

7. The electricity related device according to claim 4, wherein the core wires within one of the multi-core cables are conductors of a same material, or conductors of two or more different materials; or conductor materials of two or more of the multi-core cables are different from each other; or some of the individual core wires of the multi-core transmission cables can be made of any material so as to be uninsulated, and the uninsulated core wires are configured for purposes other than transmitting electric energy and/or an electrical signal.

8. The electricity related device according to claim 4, wherein the core wires used for transmission of the multi-core cable used in the electricity related device have a same diameter; or the multi-core cables used in the electricity related device are of a circular cross section; or each of the core wires used for transmission of the multi-core cable used in the electricity related device is of a circular cross section; or multiple core wires of the multi-core transmission cable are stranded to form one transmission channel; or multiple core wires of the multi-core transmission cable are linearly collocated without being stranded, to form one transmission channel; or multiple core wires are in different lengths, with part of the multiple core wires stranded and the remaining being linear, and the stranded and the linear wires forming one transmission channel.

9. The electricity related device according to claim 4, wherein one end or both ends of the multi-core cable is provided with a plug connector, and the plug connector is configured for connection with individual units within an electricity related device having a corresponding plug connector, or for connection with an electricity related device having a corresponding plug connector; and the multi-core cable is provided with a shielding layer, a vibration reducing layer or a filtering magnetic ring, or the multi-core cable has one or more transmission channels, or the multi-core cable is free of a peripheral insulation layer.

10. The electricity related device according to claim 4, wherein one or more of the multi-core cables each have more than one transmission channels.

11. The electricity related device according to claim 4, wherein the multi-core cables used in the electricity related device are subjected to an aging treatment when being energized, during manufacture of the cables or the electricity related device.

12. The electricity related device according to claim 4, wherein the electricity related device is a filtering device, and the filtering device is provided with a multi-core cable or single-core cable with a length of more than 50 cm, and is configured to attenuate harmonics, ripples and noises from electric energy and/or an electrical signal.

13. The electricity related device according to claim 12, wherein a starting end and a trailing end of the cable used for filtration have unequal diameters, with the starting end having a diameter larger than that of the trailing end;
or the starting end of the cable used for filtration is provided with a step-up transformer, and the trailing end of the cable used for filtration is provided with a step-down transformer; or the cable used for filtration is exposed to insulating oil; or the filtering device is provided with a filtering unit for low-order harmonics.

14. An electric energy and/or electrical signal transmission network system, comprising multi-core transmission cables for transmitting AC electric energy, DC electric energy, an electrical signal or both electric energy and an electrical signal, wherein one or part or all of the multi-core transmission cables have individual core wires used for transmission insulated from each other, with the core wires used for transmission provided in the multi-core transmission cables.

15. The network system according to claim 14, wherein within the multi-core cable used in the network system, individual core wires used for transmission are insulated from each other by adopting an insulation solution, in which surfaces of the core wires are coated with an insulating paint, or wrapped with an oxide insulation layer, or wrapped with an electrostatic coating; or insulated segments and bare wire segments are provided alternately, or bare core wires and insulated core wires are arranged alternately; or the core wires are wound with a strip-like insulator, or wrapped with a powder insulation layer, or wrapped with a release layer and an insulation layer; or a wrapped insulation layer falls off automatically after a period of time, or falls off when being rubbed by a finger; or a positioning device is used to form a spatial distance between the core wires.

16. The network system according to claim 15, wherein the insulating paint is polyurethane, or a main component of the insulating paint comprises polyurethane.

17. The network system according to claim 14, wherein an object to be transmitted by the network system is low-voltage AC electric energy.

18. The network system according to claim 14, wherein the core wires within one of the multi-core cables are conductors of a same material, or conductors of two or more different materials; or conductor materials of two or more of the multi-core cables are different; or some of the individual core wires of the multi-core transmission cables are made of any material so as to be uninsulated, and the uninsulated core wires are configured for purposes other than transmitting electric energy and/or an electrical signal.

19. The network system according to claim 14, wherein the core wires used for transmission of the multi-core cables used in the network system have a same diameter; or the multi-core cables used in the network system are of a circular cross section; or the core wires used for transmission of the multi-core cables used in the network system are of a circular cross section; or multiple core wires of the multi-core transmission cable are linearly collocated without being stranded, to form one transmission channel; or multiple core wires are in different lengths, some of multiple core wires stranded and the remaining being linear, and the stranded and the linear wires forming one transmission channel.

20. The network system according to claim 14, wherein one end or both ends of the multi-core cable is provided with a plug connector, and the plug connector is configured for connection with individual units within an electricity related device having a corresponding plug connector, or for connection with an electricity related device having a corresponding plug connector; and the multi-core cable is provided with a shielding layer, a vibration reducing layer or a filtering magnetic ring, or the multi-core cable is free of a peripheral insulation layer.
